(19) United States
(12) Patent Application Publication
(10) Pub. No.: US 2025/0200645 A1
(43) Pub. Date: Jun. 19, 2025

(54) SYSTEMS AND METHODS FOR ONLINE PAYMENT ON A PAYMENT TERMINAL

(71) Applicant: VeriFone, Inc., Wilmington, DE (US)

(72) Inventors: Claudia Vasiliu, Bucharest (RO); Mihai Radu, Bucharest (RO); Konstantin Indjov, Amsterdam (NL); Olegs Gumennikovs, Riga (LV)

(73) Assignee: VeriFone, Inc., Wilmington, DE (US)

(21) Appl. No.: 18/840,584

(22) PCT Filed: Feb. 28, 2022
(86) PCT No.: PCT/US2022/070860

§ 371 Date: Aug. 22, 2024

(51) Int. Cl. G06Q 30/0601; G06Q 20/22; G06Q 20/30

(52) U.S. Cl. CPC G06Q 30/0641; G06Q 20/29; G06Q 20/308

(57) ABSTRACT

Methods and systems for facilitating an omnichannel transaction using a retail payment device are provided. The method includes: obtaining a checkout request for an order of an amount by a customer; receiving an electronic checkout option selected by the customer, generating a checkout link to a web page for the customer to process a payment of the amount by the electronic checkout option from the receiving, where the web page is operatively coupled to a payment gateway; delivering to a customer device, the checkout link for the customer via a link delivery method selected by the customer, where the customer device is operatively coupled to the payment gateway via the web page; and updating status of the payment of the amount requested with the checkout link with the payment gateway.

### FIELD OF THE DISCLOSURE

Aspects and implementations of the present disclosure are generally directed to online payment systems and methods on a payment terminal, and more specifically, systems and methods for facilitating an omnichannel transaction using a retail payment device.

### BACKGROUND

Conventionally, card-present retail payment devices are configured to only accept credit cards and bank cards. Also, card-present retail payment devices do not allow for installment payments, deferred payment options, or subscription services. Further, card-present retail payment devices do not allow for payment via cryptocurrencies and other electronic payment methods.

### SUMMARY OF THE DISCLOSURE

The present disclosure is directed to methods and systems for online payment on a retail payment terminal via a combination of merchant and customer devices.

In one example, a method is provided, the method including: obtaining, by one or more processors on a merchant device operatively coupled to a payment gateway, a checkout request for an order of an amount by a customer: receiving, by the one or more processors, an electronic checkout option selected by the customer: generating, by the one or more processor, a checkout link to a web page for the customer to process a payment of the amount by the electronic checkout option, where the web page is operatively coupled to the payment gateway; delivering, by the one or more processors, to a customer device, the checkout link for the customer via a link delivery method selected by the customer, where the customer device is operatively coupled to the payment gateway via the web page; and updating, by the one or more processors, a status of the payment of the amount requested with the checkout link with the payment gateway.

In one aspect, the method also including: ascertaining that the customer is not present at a location of the merchant device but communicating with a merchant operating the merchant device.

In one aspect, the method also including: ascertaining that the order includes an item to be backordered, where the electronic checkout option indicates that the amount is due by the time the item backordered would be available for the customer.

In one aspect, the method also including: providing additional transaction services only available from the electronic checkout option, the additional transaction services selected from the group consisting of a deferred payment, an installment payment, a recurring purchase, and combinations thereof.

In one aspect, the method also including: setting an expiration timer for the checkout link for a window during which the customer can process the payment; and based on ascertaining that the payment has been posted prior to the expiration timer of the checkout link runs out, updating the status of the payment of the amount requested with the checkout link with the payment gateway as being paid on the merchant device.

In one aspect, the method also including: setting an expiration timer for the checkout link for a window during which the customer can process the payment; and based on ascertaining that the expiration timer of the checkout link had run out, updating the status of the payment of the amount requested with the checkout link with the payment gateway as being canceled on the merchant device.

In one aspect, the method also including: ascertaining that the order includes an item to be backordered, where the electronic checkout option indicates that the amount is due by the time the item being backordered would be available for the customer: in the generating of the checkout link, setting a due date no sooner than an estimated delivery date of the item being backordered by setting a deferred payment service with the electronic checkout option; and storing the order in a pending checkout list of the merchant device.

In another example, a system is provided, the system including: a memory: one or more processors in communication with the memory; and program instructions executable by the one or more processors via the memory configured to: obtain, by a merchant device operatively coupled to a payment gateway, a checkout request for an order of an amount by a customer: receive an electronic checkout option selected by the customer: generate a checkout link to a web page for the customer to process a payment of the amount by the electronic checkout option from the receiving, where the web page is operatively coupled to the payment gateway: deliver to a customer device, the checkout link for the customer via a link delivery method selected by the customer, where the customer device is operatively coupled to the payment gateway via the web page; and update, by the one or more processors, a status of the payment of the amount requested with the checkout link with the payment gateway.

In one aspect, the program instructions executable by the one or more processors via the memory are further configured to: ascertain that the customer is not present at a location of the merchant device but communicating with a merchant operating the merchant device.

In one aspect, the program instructions executable by the one or more processors via the memory are further configured to: ascertain that the order includes an item to be backordered, where the electronic checkout option indicates that the amount is due by the time the item backordered would be available for the customer.

In one aspect, the program instructions executable by the one or more processors via the memory are further configured to: provide additional transaction services only available from the electronic checkout option, the additional transaction services selected from the group consisting of a deferred payment, an installment payment, a recurring purchase, and combinations thereof.

In one aspect, the program instructions executable by the one or more processors via the memory are further configured to: set an expiration timer for the checkout link for a window during which the customer can process the payment; and based on ascertaining that the payment has been posted prior to the expiration timer of the checkout link runs out, update the status of the payment of the amount requested with the checkout link with the payment gateway as being paid on the merchant device.

In one aspect, the program instructions executable by the one or more processors via the memory are further configured to: set an expiration timer for the checkout link for a window during which the customer can process the payment; and based on ascertaining that the expiration timer of the checkout link had run out, update the status of the payment of the amount requested with the checkout link with the payment gateway as being canceled on the merchant device.

In one aspect, the program instructions executable by the one or more processors via the memory are further configured to: ascertain that the order includes an item to be backordered, where the electronic checkout option indicates that the amount is due by the time the item being backordered would be available for the customer: set a due date no sooner than an estimated delivery date of the item being backordered by setting a deferred payment service with the electronic checkout option; and store the order in a pending checkout list of the merchant device.

In still another example, a method is provided, the method including: receiving, by one or more processors on a customer device operated by a customer, a checkout link to a web page for the customer from a merchant device for a retail purchase, the web page being to process a payment of an amount of an order for the customer by an electronic checkout option; accessing, by the one or more processors, the web page led by the checkout link on a web browser of the customer device, the web page being operatively coupled to a payment gateway for the merchant device via a digital communication network: obtaining, by the one or more processors, payment data from the customer interactively providing the payment data into input fields of the web page for processing the payment for the amount: sending, by the one or more processors, the payment data for the electronic checkout option to the payment gateway; receiving, by the one or more processors, a payment confirmation and a receipt from the payment gateway.

In one aspect, the checkout link to the web page for the order of the customer is in a form of Uniform Resource Locator (URL) to the web page for the electronic checkout option embedded in an email message, a short message service message, or a messenger app notification, as selected by the customer.

In an aspect, the checkout link to the web page for the order of the customer is in a form of Quick Response (QR) code encoding a Uniform Resource Locator (URL) to the web page for the electronic checkout option for optical input for the customer device.

In an aspect, the web page includes electronic currencies and digital wallet credits as available sources of fund to pay for the order, and where the payment data from the customer selects a source of fund amongst the electronic currencies and the digital wallet credits.

In an aspect, a status of the payment available for the merchant device is automatically synchronized with the customer device via the payment gateway subsequent to the payment confirmation and the receipt became available to the customer device.

In an aspect, the checkout link is set with a due date no sooner than an estimated delivery date of any item being backordered.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a diagram for functional components of a an omnichannel checkout system according to the present disclosure.

FIG. 2 is a flowchart illustrating exemplary steps of the merchant device in the omnichannel checkout system according to the present disclosure.

FIG. 3 is a flowchart illustrating exemplary steps of the customer device in the omnichannel checkout system according to the present disclosure.

FIG. 4 depicts exemplary displays on the merchant device in certain of blocks of FIG. 2 in the omnichannel checkout system according to the present disclosure.

FIG. 5 depicts exemplary displays on the merchant device interacting with the customer device 130 according to the present disclosure.

FIG. 6 depicts exemplary displays on the merchant device and the customer device at the conclusion the checkout request of block 210 according to the present disclosure.

FIG. 7 depicts an exemplary schematic diagram of a payment device, focusing primarily on processing and components useful for completing the functions and methods described in the present disclosure.

### DETAILED DESCRIPTION OF EMBODIMENTS

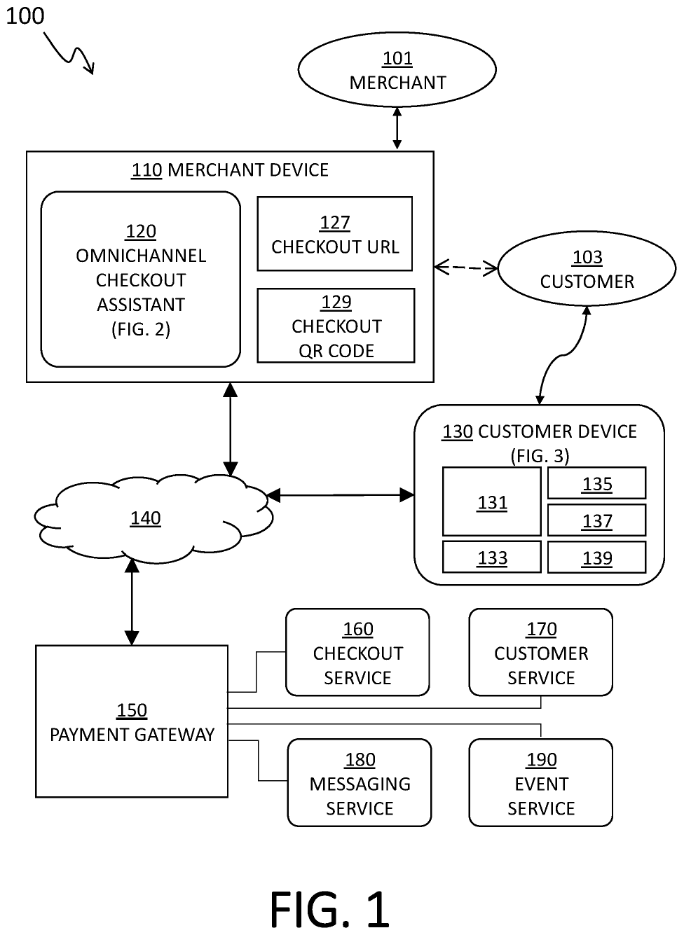

The present disclosure is directed to online payment systems and methods on a payment terminal, and in particular to methods and systems for facilitating an omnichannel transaction using a retail payment device. The omnichannel functionality of the present disclosure offers a wide variety of payment options and checkout services that had not been available in retail devices. The present disclosure provides omnichannel capability that allows for seamless and effortless, high-quality customer experiences that occur within and between contact channels from checkout services at retail devices. The following description should be read in view of FIGS. 1-7.

FIG. 1 is a diagram for functional components of an omnichannel checkout system 100 according to the present disclosure.

The omnichannel checkout system 100 includes a merchant device 110, a customer device 130, and a payment gateway 150, respectively coupled to a digital communication network 140 for data connection.

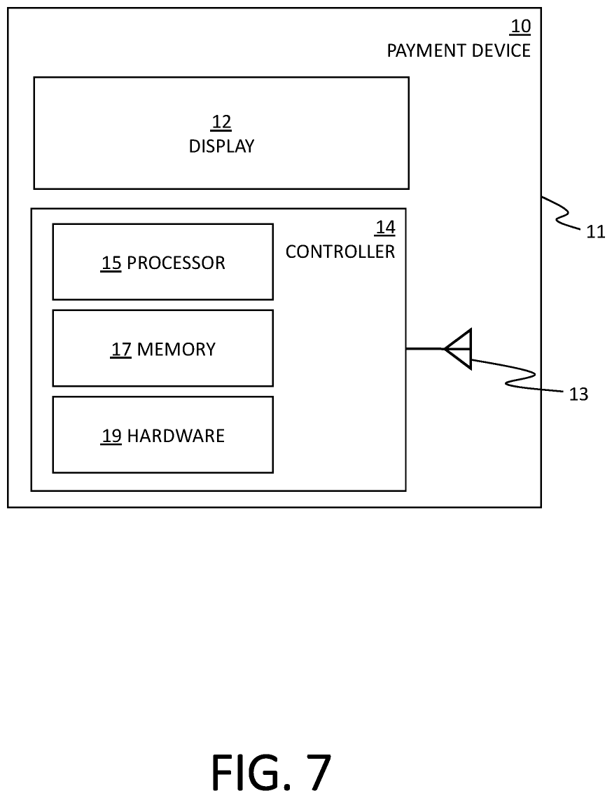

The merchant device 110 is operated by a merchant 101 who runs a retail business from a physical store. The merchant device 110 is located at the physical store. The merchant device 110 processes payments from shoppers at the retail business to the merchant 101 by accessing the payment gateway 150. The merchant device 110 is an example of a payment device 10 of FIG. 7. The merchant device 110 includes an omnichannel checkout assistant 120 that processes checkout requests for payments to the merchant 101 and generates a checkout Uniform Resource Locator (URL) 127, or a checkout Quick Response (QR) code 129, or both, corresponding to a checkout request including the amount due. The checkout URL 127 or the checkout QR code 129 is a hyperlink to an electronic checkout option in which a payment transaction is performed between the customer device 130 and the payment gateway 150 via the digital communication network 140. The electronic checkout option is also referred to as a pay-by-link option in the present disclosure.

The customer device 130 is operated by a customer 103 who shops at the retail business of the merchant 101. The customer 103 can be at the physical store for the retail business of the merchant 101 or calling the merchant 101 for checkout of an order while located off-site location from the physical store, finalizing the order that had been previously placed by choosing from some of tryout products sent for selection or placing the order afresh from offline or online catalogs and any type of merchandise information from the retail business of the merchant 101. The customer device 130 includes a web browser 131, an email viewer 133, a Short Message Service (SMS) messenger 135, a QR code input mechanism 137 including a QR code reader application and an optical data input interfaces such as camera, and an e-currency app or account 139. The web browser 131 of the customer device 130 can open a web page corresponding to the checkout URL 127 or the checkout QR code 129 sent from the merchant device 110 for payment processing. The email viewer 133 of the customer device 130 can receive an email including the checkout URL 127 or the checkout QR code 129 sent from the merchant device 110 and the customer 103 would proceed to the web browser 131 by clicking the checkout URL 127 or by scanning the checkout QR code 129. The SMS messenger 135 of the customer device 110 can receive a text message including the checkout URL 127 sent from the merchant device 110 and includes any type of application messengers that can send in a web link. The QR code reader and optical input 137 can receive the checkout QR code 129 sent from the merchant device 110 for payment processing. The e-currency app or account 139 on the customer device 130 can be used as a source of fund to process payments requested in the checkout URL 127 or the checkout QR code 129. Few examples of e-commerce exclusive payment methods include, but are not limited to, PayPal, Venmo, Apple Pay, Alipay, Klarna, PaySafeCard, and cryptocurrency including Coinbase Wallet, Exodus, Trust Wallet, Electrum Wallet, and digital currency exchange accounts such as Coinbase, Coinbase Pro, Cash App, Bisq, Binance, based on respective digital wallet tools interacting to a blockchain.

The customer device 130 can be any type of computing device such as a desktop computer, a mobile phone, or a tablet for the customer 130 who is located off-site from the physical store of the merchant 101. The customer device 130 can be a certain type of personal mobile device such as a smartphone that can be carried on the person of the customer 103 in cases the customer 103 is at the physical store of the merchant 101.

The digital communication network 140 is a combination of one or more digital communication networks such as the Internet, Virtual Private Networks (VPNs), in various physical formats including but not limited to, Ethernet cable network, optical cable network, or a wireless network.

The payment gateway 150 is a payment service provider for the merchant 103 that handles payment card transactions and other e-payment checkout transactions via the merchant device 110. The payment gateway 150 can be operatively coupled to a plurality of third-party payment processors for e-commerce transactions between the merchant 101 and the customer 103 that are not available in conventional retail merchant devices.

The payment gateway 150 is operatively coupled to payment network for brand credit cards and bank cards to handle all conventional payment transactions as in conventional payment devices, which are not shown in FIG. 1. Particularly in aspects of the omnichannel checkout system 100, the payment gateway 150 provides a checkout service 160, a customer service 170, a messaging service 180, and an event service 190 for the merchant device 110.

The checkout service 160 of the payment gateway 150 is a destination of the checkout URL 127 or the checkout QR code 129, offering a web page for processing payments for the customer 103 regarding the order. The checkout service 160 of the payment gateway 150 makes numerous e-payment providers available for the customers 103 to process payments through the checkout URL 127 or the checkout QR code 129. The customer 103 can either put in payment details of conventional card payment transaction or provide e-currency to other checkout method selected by the customer 103 upon requesting checkout for the order.

The customer service 170 of the payment gateway 150 creates and manages respective customer accounts corresponding to customers including the customer 103. Regarding aspects of the omnichannel checkout system 100, information in a customer account for the customer 103 includes, but is not limited to, preferred electronic checkout options, preferred delivery method checkout links, any current pending transactions including backordered items, recurring transactions, canceled and completed orders, respective to the customer 103. The merchant 101 can access order statuses and information relevant to orders of the customer 103 placed from the merchant device 110 or that should be fulfilled by the merchant 101.

The messaging service 180 of the payment gateway 150 sends information relevant to the electronic checkout to the customer 103 including, but not limited to, the checkout URL 127, the checkout QR code, a payment processing status update, a receipt for a successful payment, or any other notification for the customer 103. The messaging service 180 of the payment gateway 150 includes all types of outgoing information to the customer 103 including, but not limited to, e-mails, SMS texts, app notification, etc., by use of contact information of the customer 103 that is being provided upon checkout on the merchant device 110 or being stored for the customer 103 in the customer account with the customer service 170 from previous purchases. Examples of contact information of the customer 103 include, but are not limited to, a mobile phone number, an e-mail address, a shipping address, etc.

The event service 190 of the payment gateway 150 sends webhooks that seeks action on the customer 103 for events that the customer 103 might be interested in relation with the order history of the customer 103 as recorded in the customer service 170 or when the customer 103 needs to act on any upcoming recurring transactions or a payment due date for a deferred payment checkout option on pending transactions.

The checkout service 160 of the payment gateway 150 can offer value-added checkout services and e-commerce exclusive payment methods that are not available from conventional retail devices. For example, by use of the electronic checkout option or the pay-by-link checkout, from the merchant device 110 made available for the customer 103 on the customer device 130 by accessing the checkout URL 127 or the checkout QR code 129, the checkout service 160 of the payment gateway 150 can set up installment payments for orders in a certain price range by coordinating the customer service 180, the messaging service 180, and the checkout service 160, turn on a deferred payment option for backordered items to be due around an estimated delivery date of the item being backordered for the customer 103 by coordinating the customer service 180, the messaging service 180, the event service 190, and the checkout service 160, or set up recurring transactions by coordinating the customer service 180, the messaging service 180, the event service 190, and the checkout service 160. The customer 103 can interact with the payment gateway 150 in privacy via the checkout URL 127 on the customer device 130 and take advantage of various e-commerce transactions and use the e-currency available to the customer 103 at the retail business by the merchant 101 as noted above.

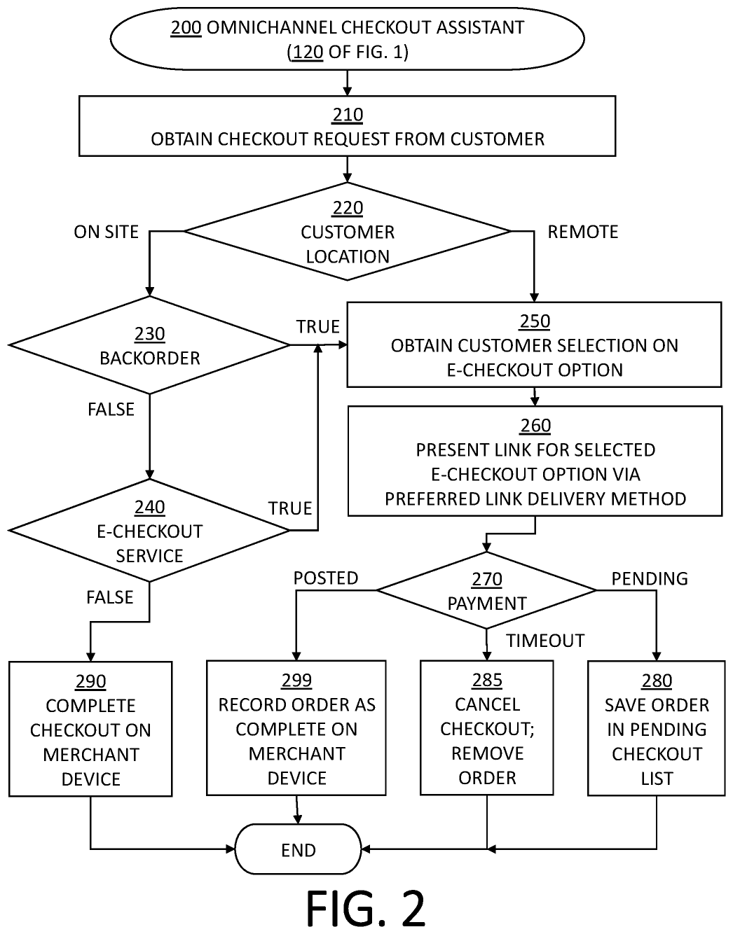

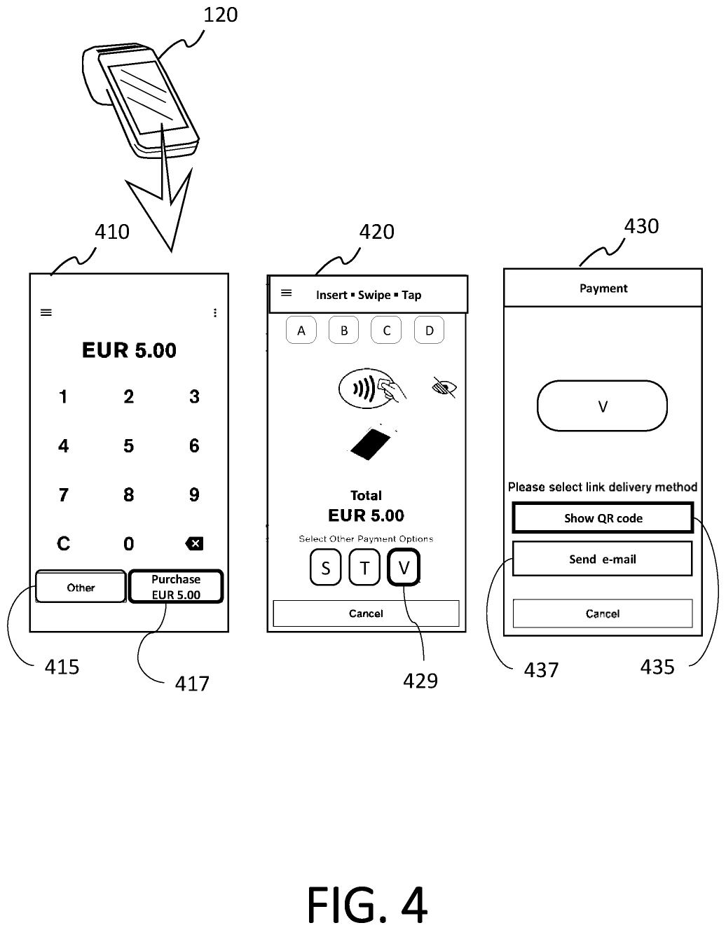

FIG. 2 is a flowchart 200 illustrating exemplary steps of the merchant device 110 in the omnichannel checkout system 110 according to the present disclosure. FIGS. 4-6 depict exemplary displays on the merchant device 110 and on the customer device 130 interacting with the merchant device 110 according to the present disclosure.

Blocks 210 through 270 of FIG. 2 are presented to show a combination of steps logically supporting operations of the omnichannel checkout assistant 120 of the merchant device 110 as presented in the present disclosure. The decision blocks 220, 230, and 240) collectively represent a set of decisions to be made for the omnichannel checkout system 100 rather than any particular order of making such decisions.

In block 210, the omnichannel checkout assistant 120 of the merchant device 110 obtains a checkout request for items in an order from the customer 103, as the merchant 101 inputs respective prices of the items in the order to the merchant device 110 by scanning or typing in item codes. Screenshot 410 of FIG. 4 depicts a screen display on the merchant device 110 after the amount for the order was entered by the merchant 101. Then, the omnichannel checkout assistant 120 proceeds with block 220.

In certain embodiments, the omnichannel checkout assistant 120 proceeds with block 230 after performing 210 to determine payment options for the customer 103 regardless of a location of the customer 103.

In block 220, the omnichannel checkout assistant 120 optionally determines if the customer 103 is remotely located. The merchant 101 operating the omnichannel checkout assistant 120 optionally inputs a location of the customer 103 in cases where the customer 103 is not directly interacting with the merchant device 110. If the omnichannel checkout assistant 120 determines that the customer 103 is on site at the physical store, then, the omnichannel checkout assistant 120 proceeds with block 230. If the omnichannel checkout assistant 120 determines that the customer 103 located off site and the merchant 101 is processing the checkout request to be processed remotely, then, the omnichannel checkout assistant 120 proceeds with block 250.

At the conclusion of block 220, the merchant 101 selects “Purchase” button 417 in screenshot 410 of FIG. 4 if the customer 103 is remote to process payment by electronic checkout. Conventionally, the merchant 101 would have received payment card information over the phone from the customer 103 calling in to place the order. If the customer 103 wishes to use a type of payment methods that requires a physical card rather than card information to process a payment on the merchant device 110, the order may not be placed without an electronic checkout option.

In block 230, the omnichannel checkout assistant 120 determines whether the order can be fulfilled immediately, or any item is to be backordered. If the omnichannel checkout assistant 120 determines that the order does not include any backorder item, then, the omnichannel checkout assistant 120 proceeds with block 240. If the omnichannel checkout assistant 120 determines that the order include one or more items to be backordered, then, the omnichannel checkout assistant 120 proceeds with block 250 for an electronic checkout with a deferred payment option so that the customer 103 would pay only when the order is fulfilled.

At the conclusion of block 230, the merchant 101 selects “Purchase” button 417 in screenshot 410 of FIG. 4 if the order includes any backordered item to process payment with a deferred payment option by electronic checkout.

In block 240, the omnichannel checkout assistant 120 determines whether the customer 103 wishes the electronic checkout option for additional services with the checkout such as paying in installments, deferred payment options, or setting up a subscription, or to use a certain digital payment method exclusive to e-commerce transactions selected by the customer 103 that is not available from the merchant device 110 to pay for the order, including but not limited to cryptocurrency and digital wallet credits.

If the omnichannel checkout assistant 120 determines that the customer 103 wishes to pay with electronic checkout options for any one of the additional services, then, the omnichannel checkout assistant 120 proceeds with block 250. If the omnichannel checkout assistant 120 determines that the customer 103 will pay by conventional card payment transaction on the merchant device 110 without requesting any additional services supported with the electronic checkout options, then, the omnichannel checkout assistant 120 proceeds with block 290.

At the conclusion of block 240, the merchant 101 selects “Purchase” button 417 in screenshot 410 of FIG. 4 if the customer 103 requests additional services and payment methods only available from electronic checkout. If the customer 103 will check out with a conventional payment card transaction, the merchant 101 selects “purchase EUR 5.00” button 417 in screenshot 410.

In block 250, the omnichannel checkout assistant 120 obtains the customer selection on the electronic checkout options on which payment service provider the customer 103 would use, including any e-commerce exclusive payment methods, as well as additional services based on electronic checkout, including but not limited to, payment in installments, a deferred payment options, or setting up a subscription, as supported by a combination of the checkout service 160, the customer service 170, the messaging service 180, and the event service 190 offered by the payment gateway 150. Then, the omnichannel checkout assistant 120 proceeds with block 260.

Screenshot 420 of FIG. 4 depicts a screen display on the merchant device 110 at block 250, after “Purchase” button 417 from screenshot 410 was selected by the merchant 101. Areas A, B, C, and D in screenshot 420 are for respective brand logos for payment cards accepted by the merchant device 110. Buttons S. T, and V under “Select Other Payment Options” marking in screenshot 420 are assigned for respective other payment options and the merchant 101 selects button V 429 as the customer 103 selects a payment option corresponding to button V 429 at block 250.

In certain embodiments of the present disclosure, the merchant 101 processes the order on the merchant device 110 for the customer 103 who is remote calling in to finalize the order that had been previously placed by choosing from some of tryout products sent for selection to the customer 103. In the same embodiments of the present disclosure, the customer 103 who is remote can call or otherwise communicate with the merchant 101 to place a new order based on product codes from offline or online catalogs, brochures, ads, or any types of information that identify products available from the retail business of the merchant 101.

In block 260, the omnichannel checkout assistant 120 sends a link for selected checkout option to the customer 103 via a preferred link delivery method of the customer 103. The omnichannel checkout assistant 120 generates the checkout URL 127 or the checkout QR code 129 according to the delivery method selected by the customer 103. Then, the omnichannel checkout assistant 120 proceeds with block 270.

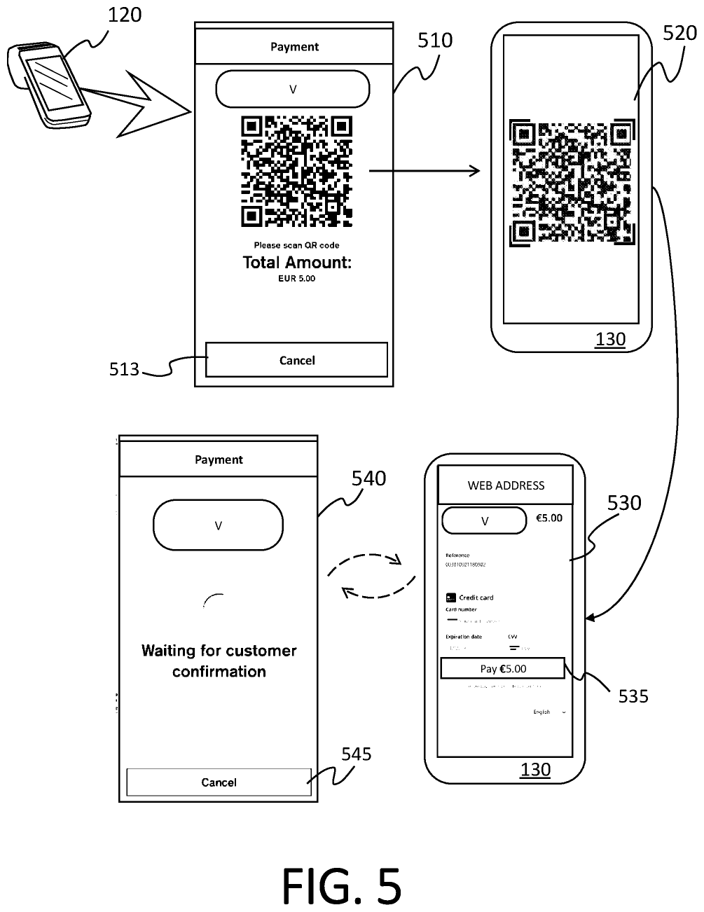

Screenshot 430 of FIG. 4 depicts a screen display on the merchant device 110 at block 260, after V button 429 from screenshot 420 was selected by the merchant 101. The merchant 101 selects “Send QR code” button 435 if the customer 103 want to receive the link to electronic checkout of the order in a QR code. Screenshot 510 of FIG. 5 depicts the checkout QR code 129 displayed on the merchant device 110 when the customer 103 selected the QR code option as a delivery method at block 260.

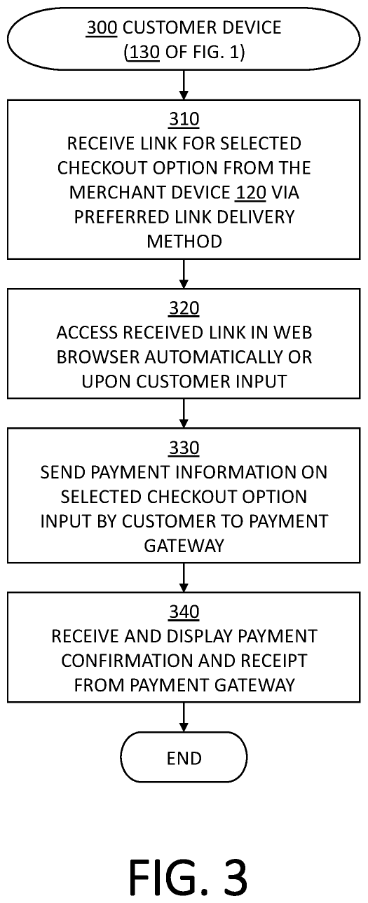

In block 270, the omnichannel checkout assistant 120 determines a payment status of the electronic checkout sent to the customer in block 260. After the electronic checkout link was sent to the customer device 130 in an email with the checkout URL 127 or the checkout QR code 129, the customer 103 will input payment details on a web page directed by the checkout URL 127 or the checkout QR code 129. Detailed operations on the customer device 130 are presented in FIG. 3 and corresponding description.

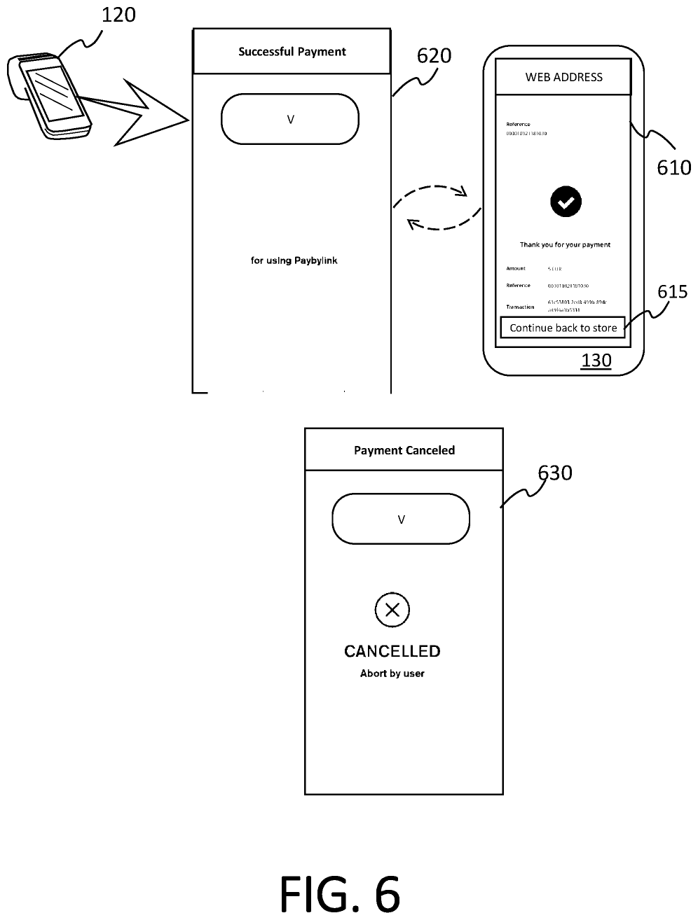

Screenshot 510 of FIG. 5 depicts the checkout QR code 129 displayed on the merchant device 110 when the customer 103 selected the QR code option as a delivery method at block 260. The customer 103 may or may not scan the checkout QR code 129 from the merchant device 110, and if the checkout QR code 129 is not scanned, then the merchant 101 can cancel the checkout QR code 129 by selecting “Cancel” button 513 in screenshot 510. If the customer 103 scans the checkout QR code 129, as depicted in screenshot 520 of FIG. 5, the customer 103 automatically follows the link of the checkout QR code 129 to a web page for payment processing, as depicted in screenshot 530 of FIG. 5. Screenshot 540 depicts display on the merchant device 110 when the merchant device 110 is waiting for the payment status in real time as the customer 103 is working on the payment information in the web page for payment processing according to the link in the checkout QR code 129. Screenshot 620 of FIG. 6 depicts a screen display on the merchant device 110 upon the payment has been properly posted in time and the payment status was updated from the payment gateway 150.

At block 270, there can be various payment scenarios based on a combination of the electronic checkout option or additional services requested with the electronic checkout. In cases where the payment is supposed to be posted immediately as described above, particularly when the checkout QR code 129 was sent to the customer 103 with an expiration timer for a few minutes, then, the merchant device 110 would receive the payment status real time as the payment by link sent in block 260 is processed while the checkout session is active. If the payment is posted before the timer expires, then the omnichannel checkout assistant 120 determines that the payment is posted and proceeds with block 299.

If the omnichannel checkout assistant 120 at block 270 determines that the payment has not been posted until the expiration timer ran out, then, the omnichannel checkout assistant 120 proceeds with block 285. Screenshot 630 of FIG. 6 depicts a screen display on the merchant device 110 of the payment status if the payment has not been posted successfully before the expiration timer runs out at block 270.

At block 270), in cases where the payment is supposed to be posted later by a certain calendar dates for a delivery of backordered items or for a recurring transaction of regularly purchased items or a kind of items to be selected by experts as in subscriptions for wine, cuisines, or clothing, the omnichannel checkout assistant 120 sends out the checkout URL 127 before a certain due date via the preferred link delivery method noted in block 260. For recurring transactions, the customer service 170 and the messaging service 180 by the payment gateway 150 can process block 260 automatically. If the omnichannel checkout assistant 120 determines that the payment is pending for the moment because it is due later, then, the omnichannel checkout assistant 120 proceeds with block 280.

In block 280, the omnichannel checkout assistant 120 saves the order in a pending checkout list on the merchant device 110 terminates processing the checkout request from block 210. As a backend process, the payment gateway 150 will asynchronously update the payment status on the order of the pending checkout list saved in the merchant device 110 as the payment is posted by the customer 103. Or the merchant device 110 can poll the payment gateway 150 daily or per every interval configured on the payment status of the order. Then, the omnichannel checkout assistant 120 terminates processing the checkout request from block 210.

In block 285, the omnichannel checkout assistant 120 cancels the checkout requested from block 210 and removes the order from the merchant device 110. In certain embodiments of the present disclosure, the merchant device 110, by use of the customer service 170, the messaging service 180, and the event service 190, can keep a record of a canceled order for the customer 103 and send out a message later to ask if the customer 103 is interested in reinstating the order. Then, the omnichannel checkout assistant 120 terminates processing the checkout request from block 210.

Screenshot 630 of FIG. 6 depicts a screen display on the merchant device 110 of the payment status if the payment has not been posted successfully before the expiration timer runs out at block 270. Then, the omnichannel checkout assistant 120 terminates processing the checkout request from block 210.

In block 290, the omnichannel checkout assistant 120 completes the checkout on the merchant device 110 by conventional payment card transaction, as the customer 103 selected. Then, the omnichannel checkout assistant 120 terminates processing the checkout request from block 210.

In block 299, the omnichannel checkout assistant 120 records the order of which checkout has been requested in block 210 as complete on the merchant device 110 as the payment was posted via electronic checkout in time. Then, the omnichannel checkout assistant 120 terminates processing the checkout request from block 210.

Screenshot 620 of FIG. 6 depicts a screen display on the merchant device 110 upon the payment has been properly posted in time and the payment status was updated from the payment gateway 150. Then, the omnichannel checkout assistant 120 terminates processing the checkout request from block 210.

In this disclosure, all communication between the merchant device 110 and the payment gateway 150, including the checkout service 160, the customer service 170, the messaging service 180, and the event service 190, corresponding to respective blocks described herein indicate communication between software/hardware modules in accordance with an application programming interface (API) of the payment gateway 150, including but not limited to, call or any other invocation of a necessary module with a preconfigured parameter list and respective values corresponding to parameters of the parameter list.

FIG. 3 is a flowchart 300 illustrating exemplary steps of the customer device in the omnichannel checkout system according to the present disclosure. FIGS. 5-6 depict exemplary displays on the customer device 130 while performing steps of FIG. 3 according to the present disclosure.

In block 310, the customer device 130 receives, directly from the merchant device 120, the electronic checkout link in either the checkout URL 127 or the checkout QR code 129 for the checkout option selected in block 250 of the omnichannel checkout assistant 120 via preferred link delivery method. Then, the customer device 130 proceeds with block 320.

At block 310, the customer device 130 can receive the checkout QR code 129 by scanning the checkout QR code 129 displayed on the merchant device 110 with the QR code input mechanism 137, indicating a QR reader app and an optical data interface, of the customer device 130. Screenshot 520 of FIG. 5 depicts a display on the customer device 130 at block 310 while scanning the checkout QR code 129 from the merchant device 110 in block 260, as shown in screenshot 510 of FIG. 5.

In block 320, the customer device 130 accesses the link received in the checkout URL 127 or the checkout QR code 129 from the web browser 131 of the customer device 130 either by automatic access or upon clicking the link of the checkout URL 127 embedded in the email 133 or the SMS message 135 of the customer device 130. Screenshot 530 of FIG. 5 depicts a display on the customer device 130 at block 320 while accessing the payment page by the link in the web browser 131, while the customer 103 is filling in fields for payment details. Screenshot 540 depicts a display on the merchant device 110 concurrent with screenshot 530) on the customer device 130. Then, the customer device 130 proceeds with block 330.

In block 330, the customer device 130 sends payment information on the selected checkout option input by the customer 103 to the payment gateway 150. In screenshot 530 of FIG. 5 from block 320, the customer 103 puts in the payment details on the payment page, then, the customer 103 taps/clicks “Pay € 5.00” button 535 to send the payment details to the payment gateway 150. Although screenshot 530 presents data fields for payment card transaction, the payment page open from the checkout URL 127 or the checkout QR code 129 can provide payment method options exclusive to e-commerce transactions such as digital wallet credits or cryptocurrency or certain e-payment methods that must be executed on the customer device 130, from which the customer 103 can choose to pay for the order with the merchant 101. Then, the customer device 130 proceeds with block 340.

In block 340, the customer device 130 receives and displays a payment confirmation and/or a receipt from the payment gateway 150, based on the payment had been successfully posted via the payment method the customer 103 selected and processed in block 330. Screenshot 610 of FIG. 6 depicts a display on the customer device 130 of a payment confirmation from the payment gateway 150 at block 340. As noted in FIG. 3, the merchant device 110 concurrently receives the same payment status as the customer device 130 from the payment gateway 150 in real time for certain type of electronic checkout processes, as shown in screenshot 620. Then, the customer device 130 terminates processing the checkout on the link received from block 310.

FIG. 7 depicts an exemplary schematic diagram of a payment device 10, focusing primarily on processing and components useful for completing the functions and methods in place of the merchant device 110 described in this disclosure. As shown, the payment device 10, in this example, includes a housing 11, a display 12, an antenna 13, and a controller 14. To focus more on the pertinent features of payment device 10, not shown in FIG. 7 are components for receiving payments via magnetic stripe, a chip, or Near Field Communication (NFC), components for connection to a network, such as a payment processing network, components for receiving power (e.g., a power supply), etc., which can be present in various examples of the payment device 10.

The controller 14 can include one or more processors 15, and any associated hardware 17, configured to execute at least one step (e.g., the steps described in connection with the method described herein) stored in a non-transitory storage medium, such as a memory 17, to perform the various functional components described in this disclosure. For example, the controller 14 can be a microprocessor or microcontroller executing steps stored in the memory 17 (either as firmware or software). The antenna 13, as described above, can be any suitable antenna for determining a range to a payment transceiver. Although the antenna 13 is shown disposed within the housing 11, it should be understood that in, alternative examples, the antenna 13 can be disposed on the housing 11, extending from the housing 11, or remote from the housing 11. Further, in various alternative examples, as described above, the controller 14 can receive signals from multiple antennas and/or transmit data encoded by the processors 15 in communication with one or more antennas. The display 12 can be employed to notify a user of information such as totals before a payment is approved, and status updates on the processing, such as approval or denial.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising.” “including.” “carrying,” “having,” “containing,” “involving.” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow chart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled. While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer implemented method comprising:
obtaining, by one or more processors on a merchant device operatively coupled to a payment gateway, a checkout request for an order of an amount by a customer;
receiving, by the one or more processors, an electronic checkout option selected by the customer;
generating, by the one or more processors, a checkout link to a web page for the customer to process a payment of the amount by the electronic checkout option, wherein the web page is operatively coupled to the payment gateway;
delivering, by the one or more processors, to a customer device, the checkout link for the customer via a link delivery method selected by the customer, wherein the customer device is operatively coupled to the payment gateway via the web page; and
updating, by the one or more processors, a status of the payment of the amount requested with the checkout link with the payment gateway.

2. The computer implemented method of claim 1, further comprising:
ascertaining that the customer is not present at a location of the merchant device but communicating with a merchant operating the merchant device.

3. The computer implemented method of claim 1, further comprising:
ascertaining that the order includes an item to be backordered, wherein the electronic checkout option indicates that the amount is due by the time the item backordered would be available for the customer.

4. The computer implemented method of claim 1, further comprising:
providing additional transaction services available from the electronic checkout option, the additional transaction services selected from the group consisting of a deferred payment, an installment payment, a recurring purchase, and combinations thereof.

5. The computer implemented method of claim 1, further comprising:
setting an expiration timer for the checkout link for a window during which the customer can process the payment; and
based on ascertaining that the payment has been posted prior to the expiration timer of the checkout link runs out, updating the status of the payment of the amount requested with the checkout link with the payment gateway as being paid on the merchant device.

6. The computer implemented method of claim 1, further comprising:
setting an expiration timer for the checkout link for a window during which the customer can process the payment; and
based on ascertaining that the expiration timer of the checkout link had run out, updating the status of the payment of the amount requested with the checkout link with the payment gateway as being canceled on the merchant device.

7. The computer implemented method of claim 1, further comprising:
ascertaining that the order includes an item to be backordered, wherein the electronic checkout option indicates that the amount is due by the time the item being backordered would be available for the customer;
setting a due date no sooner than an estimated delivery date of the item being backordered by setting a deferred payment service with the electronic checkout option; and
storing the order in a pending checkout list of the merchant device.

8. A system comprising a memory, one or more processors in communication with the memory, and program instructions executable by the one or more processors via the memory configured to:
obtain, by a merchant device operatively coupled to a payment gateway, a checkout request for an order of an amount by a customer;
receive an electronic checkout option selected by the customer;
generate a checkout link to a web page for the customer to process a payment of the amount by the electronic checkout option, wherein the web page is operatively coupled to the payment gateway;
deliver to a customer device, the checkout link for the customer via a link delivery method selected by the customer, wherein the customer device is operatively coupled to the payment gateway via the web page; and
update, by the one or more processors, a status of the payment of the amount requested with the checkout link with the payment gateway.

9. The system of claim 8, wherein the program instructions executable by the one or more processors via the memory are further configured to:
ascertain that the customer is not present at a location of the merchant device but communicating with a merchant operating the merchant device.

10. The system of claim 8, wherein the program instructions executable by the one or more processors via the memory are further configured to:
ascertain that the order includes an item to be backordered, wherein the electronic checkout option indicates that the amount is due by the time the item backordered would be available for the customer.

11. The system of claim 8, wherein the program instructions executable by the one or more processors via the memory are further configured to:
provide additional transaction services only available from the electronic checkout option, the additional transaction services selected from the group consisting of a deferred payment, an installment payment, a recurring purchase, and combinations thereof.

12. The system of claim 8, wherein the program instructions executable by the one or more processors via the memory are further configured to:
set an expiration timer for the checkout link for a window during which the customer can process the payment; and
based on ascertaining that the payment has been posted prior to the expiration timer of the checkout link runs out, update the status of the payment of the amount requested with the checkout link with the payment gateway as being paid on the merchant device.

13. The system of claim 8, wherein the program instructions executable by the one or more processors via the memory are further configured to:
set an expiration timer for the checkout link for a window during which the customer can process the payment; and
based on ascertaining that the expiration timer of the checkout link had run out, update the status of the payment of the amount requested with the checkout link with the payment gateway as being canceled on the merchant device.

14. The system of claim 8, wherein the program instructions executable by the one or more processors via the memory are further configured to:
ascertain that the order includes an item to be backordered, wherein the electronic checkout option indicates that the amount is due by the time the item being backordered would be available for the customer;
set a due date no sooner than an estimated delivery date of the item being backordered by setting a deferred payment service with the electronic checkout option; and
store the order in a pending checkout list of the merchant device.

15. A computer implemented method comprising:
receiving, by one or more processors on a customer device operated by a customer, a checkout link to a web page for the customer from a merchant device for a retail purchase, the web page being to process a payment of an amount of an order for the customer by an electronic checkout option;
accessing, by the one or more processors, the web page led by the checkout link on a web browser of the customer device, the web page being operatively coupled to a payment gateway for the merchant device via a digital communication network;
obtaining, by the one or more processors, payment data from the customer interactively providing the payment data into input fields of the web page for processing the payment for the amount;
sending, by the one or more processors, the payment data for the electronic checkout option to the payment gateway;
receiving, by the one or more processors, a payment confirmation and a receipt from the payment gateway.

16. The computer implemented method of claim 15, wherein the checkout link to the web page for the order of the customer is in a form of Uniform Resource Locator (URL) to the web page for the electronic checkout option embedded in an email message, a short message service message, or a messenger app notification, as selected by the customer.

17. The computer implemented method of claim 15, wherein the checkout link to the web page for the order of the customer is in a form of Quick Response (QR) code encoding a Uniform Resource Locator (URL) to the web page for the electronic checkout option for optical input for the customer device.

18. The computer implemented method of claim 15, wherein the web page includes electronic currencies and digital wallet credits as available sources of fund to pay for the order, and wherein the payment data from the customer selects a source of fund amongst the electronic currencies and the digital wallet credits.

19. The computer implemented method of claim 15, wherein a status of the payment available for the merchant device is automatically synchronized with the customer device via the payment gateway subsequent to the payment confirmation and the receipt became available to the customer device.

20. The computer implemented method of claim 15, wherein the checkout link is set with a due date no sooner than an estimated delivery date of any item being backordered.
